(19) United States
(12) Patent Application Publication
(10) Pub. No.: US 2001/0038577 A1
(43) Pub. Date: Nov. 8, 2001

(54) Polarized-dependent optical diffraction device

(76) Inventors: Hung-Lu Chang, Taichung City (TW); Der-Ray Huang, Hsinchu City (TW); Jau-Jiu Ju, Hsinchu (TW)

Correspondence Address: W. Wayne Liauh, Ph.D., J.D., Law Office of Liauh and Associates, 4224 Waialae Ave., Ste 5-388, Honolulu, HI, 96816, US

(21) Appl. No.: 09/767,799

(22) Filed: Jan. 22, 2001

(30) Foreign Application Priority Data
Apr. 18, 2000 (TW) 89107250

(51) Int. Cl. G11B 7/00

(52) U.S. Cl. 369/13

(57) ABSTRACT

A polarized-dependent optical diffraction device includes a circular polarization beam generator and a diffraction grating. A diffraction grating is formed by a circular birefractive sheet having a corrugated surface with at least each groove filled with a mass of a material of a refractive index which is substantially equal to one of the circular birefractive indices. A circular polarization beam is supplied to the diffraction grating that the circularly-polarized beams traveling in both directions along a specific optical axis have different diffraction effects so as to enhance the utilization efficiency of the light. In particular, an external magnetic field is used to change the circular birefractive indices in such a manner diffraction efficiency is changed, featuring the merit of adjustability.

### BACKGROUND OF THE INVENTION

1. Field of Invention

The present invention relates to a polarized-dependent optical diffraction device and, in particular, to a diffraction device of the optical products such as the optical pickup heads.

2. Related Art

Data stored on optical recording media such as the CD, CD-R, and DVD is retrieved with an optical pickup head. The optical pickup head focuses a laser beam into a light spot on the data storage surface of the optical disk and converts the light beam reflected from the optical disk surface carrying data signals into recognizable electrical signals for further processing.

Since the laser beam passes through the diffractive elements, the diffraction results in low efficiency of the light. It is primary technical subject for the diffraction devices used in optical pickup heads to enhance the utilization efficiency of the light in order to increase the accuracy of signal retrieval and data recording.

### SUMMARY OF THE INVENTION

It is the object of the present invention to produce different diffraction effects on circularly-polarized beams traveling in both directions along an optical axis so as to increase the utilization efficiency of the light. In particular, an external magnetic field is used to change the circular birefractive indices in such a manner diffraction efficiency is changed, featuring the merit of adjustability.

In accordance with the technology disclosed in the invention, a polarized-dependent optical diffraction device is provided to produce different physics effects on left- and right-circularly-polarized beams using the optical active material in such a way that circularly-polarized beams traveling in both direction along an optical axis have different diffraction. The optical device includes a circular polarization beam generator for converting an incident beam into a circularly-polarized beam and a grating for producing diffraction on the circularly-polarized beam passing therethrough. This grating is formed by isotropic and optical active materials interweaved on the same plane.

When an incident linearly-polarized beam passes through the circular polarization beam generator, it is converted into a circularly-polarized beam. After reflection, the polarization of the circularly-polarized beam is inversed with respect to the incident one (i.e., from left-circular polarization to right-circular polarization, and vice versa). Due to the special characteristics that the optical active material on the grating produces different physics effects on the left- and right-circularly-polarized beams, the utilization efficiency of the light can be increased.

In particular, when the magneto-optical material is employed in the grating an external magnetic field can be used to change the diffraction effects on the light, featuring the merit of adjustability.

These and additional objects and advantages, as well as other embodiments of the invention, will be more readily understood after a consideration of the drawings and the detailed description of the preferred embodiments.

### BRIEF DESCRIPTION OF THE DRAWINGS

FIG. 1 is a first embodiment of the polarized-dependent optical diffraction device of the present invention;

FIG. 2 is a second embodiment of the polarized-dependent optical diffraction device of the present invention;

FIG. 3 is a first embodiment of the optical pickup head of the present invention; and

FIG. 4 is a second embodiment of the optical pickup head of the present invention.

### DETAILED DESCRIPTION OF THE INVENTION

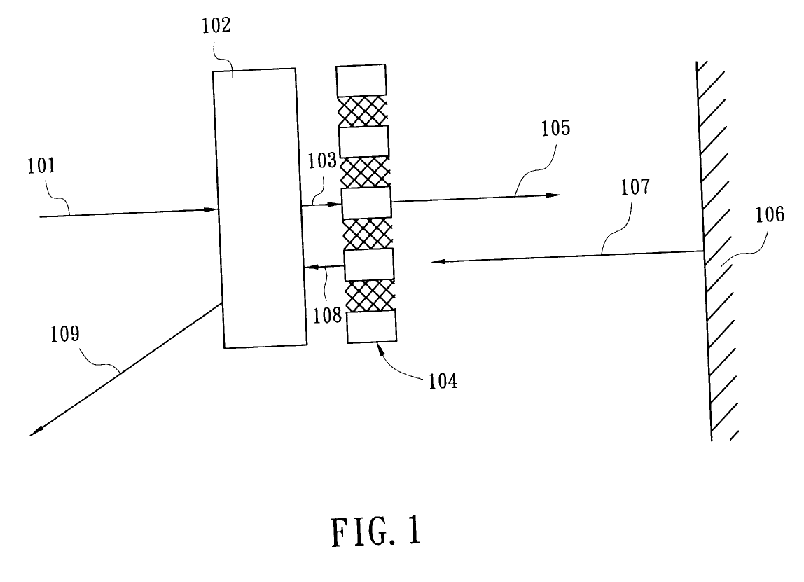

Referring to FIG. 1, the first embodiment of the polarized-dependent optical diffraction device according to the present invention is shown.

The circular polarization beam generator 102 converts an incident beam into a circularly-polarized beam.

The grating 104 is composed of isotropic and optical active materials interweaved on the same plane, with the optical active material as a stuffed material provided on the isotropic material as a substrate, or alternatively with the isotropic material as a stuffed material provided on the optical active material as a substrate, by film coating or heavy penetration. The grating 104 diffracts the reflective circularly-polarized beam.

When an incident beam 101 passes through the circular polarization beam generator 102, it turns into the circularly-polarized beam 103, which further passes through the grating 104 and forms the beam 105. The beam 105 is reflected by a reflection surface 106 and becomes a reflective circularly-polarized beam 107. The polarization direction of the reflective beam 107 is opposite to that of the incident one 105 (i.e., from left-circular polarization to right-circular polarization, and vice versa). The reflective circularly-polarized beam 107 passes the grating 104 again and produces diffraction, forming the diffracted circularly-polarized beam 108. Since the optical active material on the grating produces different physics effects on the left- and right-circularly-polarized beams, the utilization efficiency of the light increases.

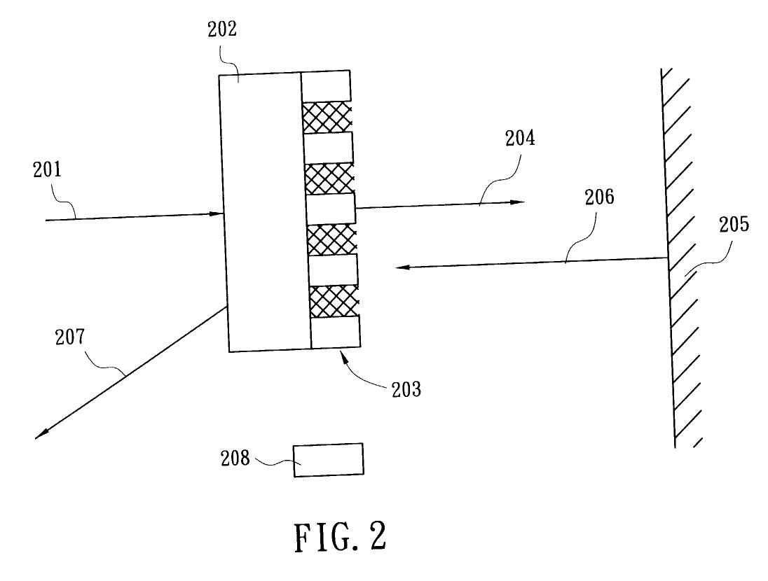

With reference to FIG. 2, the second embodiment of the polarized-dependent optical diffraction device of the invention is shown.

The ¼ λ waveplate 202 for converts the incident beam 201 into the circularly-polarized beam.

The grating 203 is composed of isotropic and optical active materials interweaved on the same plane, with the optical active material as a stuffed material provided on the isotropic material as a substrate, or alternatively with the isotropic material as a stuffed material provided on the optical active material as a substrate, by film coating or heavy penetration, and the isotropic material can be glass and the optical active material is selected from the group comprising liquid crystal, ferromagnetic materials, and cholesterics materials. The grating 203 closely connected to the ¼ λ waveplate 202 for diffracting the reflective circularly-polarized beam.

An external magnetic field 208 controls the physical properties of the magneto-optical material on the left- and right-circularly-polarized beams and thus adjusting the utilization efficiency of the light.

When an incident beam 201 passes through the ¼ λ waveplate 202, it turns into a circularly-polarized beam, which further passes through the grating 203 and produces diffraction, forming the beam 204. The beam 204 is reflected by a reflection surface 205 and becomes a reflective circularly-polarized beam 206. The polarization direction of the reflective beam 206 is opposite to that of the incident one 204 (i.e., from left-circular polarization to right-circular polarization, and vice versa). The reflective circularly-polarized beam 206 passes the grating 203 again and produces diffraction, forming a second diffracted circularly-polarized beam 207. Since the optical active material on the grating produces different physics effects on the left- and right-circularly-polarized beams, the two diffractions have different effects. The physics effects of the optical active material on the left- and right-circularly-polarized beams are controlled and changed by the external magnetic field 208 so that the utilization efficiency of the light is adjusted.

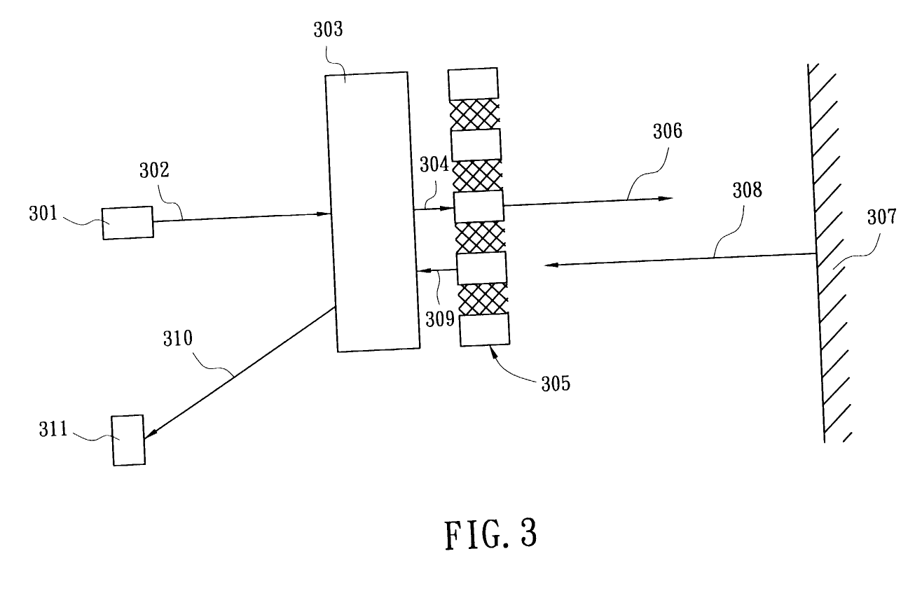

Refer to FIG. 3, the first embodiment of the optical pickup head according to the invention is shown.

The laser source 301 generates the linearly-polarized beam 302 as the laser source for reading optical recording media.

The circular polarization beam generator 303 converts the linearly-polarized beam 302 into the circularly-polarized beam 304.

The grating 305 is composed of isotropic and optical active materials interweaved on the same plane, with the optical active material as a stuffed material provided on the isotropic material as a substrate, or alternatively with the isotropic material as a stuffed material provided on the optical active material as a substrate, by film coating or heavy penetration. The grating 305 diffracts the reflective circularly-polarized beam.

The photodetector 311 receives and converts the reflective circularly-polarized beam 310 into the corresponding electrical signals.

The laser source 301 generates an incident beam 302, which passes through the circular polarization beam generator 303 and turns into a circularly-polarized beam. The incident beam 304 passes through the grating 305 to produce diffraction, forming a first diffracted circularly-polarized beam 306. After reflecting from the reflection surface 307, a reflective circularly-polarized beam 308 with the opposite polarization to the incident circularly-polarized beam (i.e., from left-circular polarization to right-circular polarization, and vice versa) passes the grating 305 again and has another diffraction pattern, forming a second diffracted circularly-polarized beam 309. This diffracted beam 309 is still circularly-polarized after passing through the circular polarization beam generator 303. Finally, the circularly-polarized beam 310 is detected by the photodetector 311 and its optical signals are converted into the corresponding electrical signals. Since the optical active material on the grating of the optical pickup head has different physics effects on the left- and right-circularly-polarized beams, the utilization efficiency of the light is increased.

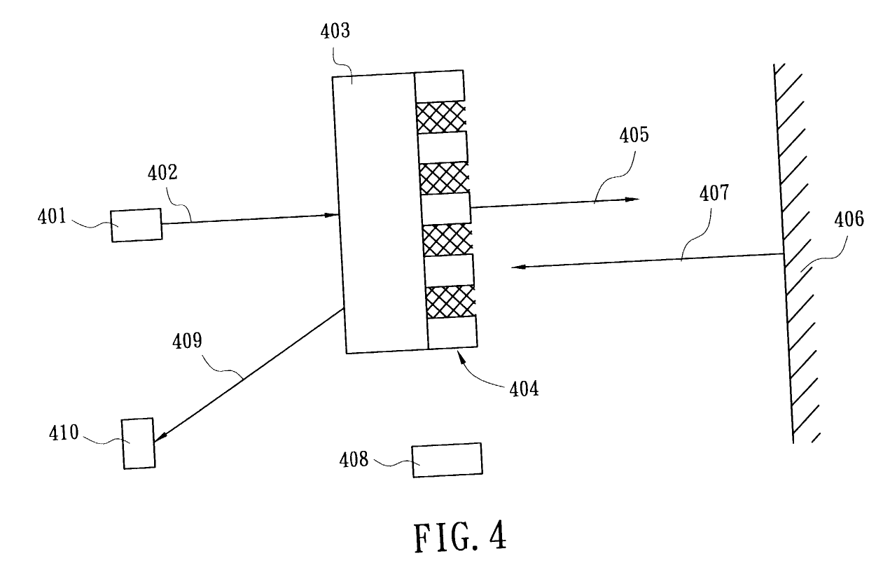

Referring to FIG. 4, the second embodiment of the optical pickup head disclosed by the invention is shown.

The laser source 401 generates the incident beam 402.

The ¼ λ waveplate 403 converts the incident beam 402 into the circularly-polarized beam.

The grating 404 is composed of isotropic and optical active materials interweaved, with the optical active material as a stuffed material provided on the isotropic material as a substrate, or alternatively with the isotropic material as a stuffed material provided on the optical active material as a substrate, by film coating or heavy penetration, and the isotropic material can be glass and the optical active material is selected from the group comprising liquid crystal, ferromagnetic materials, and cholesterics materials. The grating 404 is closely connected to the ¼ λ waveplate 403 for diffracting the reflective circularly-polarized beam. The external magnetic field 408 controls the physical properties of the magneto-optical material on the left- and right-circularly-polarized beams and thus adjusts the utilization efficiency of the light.

The photodetector 410 receives and converts the reflective circularly-polarized beam 409 into the corresponding electrical signals.

The laser source 401 generates the incident beam 402, which passes through the ¼ λ waveplate 403 and turns into the circularly-polarized beam. The incident circularly-polarized beam passes through the grating 404 and forms the beam 405. After reflecting from the reflection surface 406, a reflective circularly-polarized beam with the opposite polarization to the incident circularly-polarized beam (i.e., from left-circular polarization to right-circular polarization, and vice versa) passes the grating 404 again and has another diffraction pattern, forming the diffracted circularly-polarized beam 409. This diffracted beam 409 is detected by the photodetector 410 and the optical signals contained therein are converted into the corresponding electrical signals. Since the optical active material on the grating of the optical pickup head has different physics effects on the left- and right-circularly-polarized beams, the two diffractions differ from each other. With the external magnetic field 408 to change the direction or magnitude of the magnetic field, the diffraction efficiency of the optical active material on the left- and right-circularly-polarized beams can be adjusted. Through this adjustment of diffraction effects the utilization efficiency of the light can be modified.

The polarized-dependent optical diffraction device disclosed in the present invention allows different diffraction effects on the circularly-polarized beams traveling in both directions along a specific optical axis so as to increase the utilization efficiency of the light. This device solves the problem of low utilization efficiency when the light is diffracted twice. More particularly, when the magneto-optical material is adopted in the grating, the diffraction effects can be varied with the external magnetic field, featuring the merit of adjustability.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A polarized-dependent optical diffraction device for generating different diffraction effects on left- and right-circularly-polarized beams, which device comprises:
a circular polarization beam generator for converting an incident beam into a circularly-polarized beam; and
a grating composed of isotropic and optical active materials interweaved on the same plane for diffracting reflective circularly-polarized beams.

2. The optical diffraction device of claim 1, wherein the circular polarization beam generator is a ¼ λ waveplate.

3. The optical diffraction device of claim 1, wherein the substrate of the grating is an isotropic material and the stuffed material is an optical active material.

4. The optical diffraction device of claim 1, wherein the substrate of the grating is an optical active material and the stuffed material is an isotropic material.

5. The optical diffraction device of claim 1, wherein the stuffed material in the grating is provided on the substrate by film coating.

6. The optical diffraction device of claim 1, wherein the stuffed material in the grating is provided on the substrate by heavy penetration.

7. The optical diffraction device of claim 1, wherein the grating is closely connected to the circular polarization beam generator.

8. The optical diffraction device of claim 1, wherein the substrate of the grating is glass.

9. The optical diffraction device of claim 1, wherein the optical active material of the grating is magneto-optical material.

10. The optical diffraction device of claim 9, wherein the magneto-optical material of the grating is selected from the group comprising cholesterics type liquid crystal and ferromagnetic materials.

11. The optical diffraction device of claim 9, further comprising an external magnetic field for controlling the physics properties of the magneto-optical material on the left- and right-circularly-polarized beams and adjusting diffraction effects of the grating.

12. An optical pickup head for reading optical recording media, comprising:
a laser source for generating a linearly-polarized beam for reading optical recording media;
a ¼ λ waveplate for converting the linearly-polarized beam into a circularly-polarized beam;
a grating composed of isotropic and optical active materials interweaved for diffracting the reflective circularly-polarized beams; and
a photodetector for receiving the reflective circularly-polarized beam and converting the optical signals contained therein into the corresponding electrical signals.

13. The optical diffraction device of claim 12, wherein the substrate of the grating is an isotropic material and the stuffed material is an optical active material.

14. The optical diffraction device of claim 12, wherein the substrate of the grating is an optical active material and the stuffed material is an isotropic material.

15. The optical diffraction device of claim 12, wherein the stuffed material in the grating is provided on the substrate by film coating.

16. The optical diffraction device of claim 12, wherein the stuffed material in the grating is provided on the substrate by heavy penetration.

17. The optical diffraction device of claim 12, wherein the grating is closely connected to the circular polarization beam generator.

18. The optical diffraction device of claim 12, wherein the substrate of the grating is glass.

19. The optical diffraction device of claim 12, wherein the optical active material of the grating is magneto-optical material.

20. The optical diffraction device of claim 19, wherein the magneto-optical material of the grating is selected from the group comprising liquid crystal, ferromagnetic materials, and cholesterics materials.
